(19) United States
(12) Patent Application Publication
(10) Pub. No.: US 2006/0269227 A1
(43) Pub. Date: Nov. 30, 2006

(54) Subpicture display device utilizing micro-processor created subpicture address table and related method

(76) Inventor: Yu-Ching Hsieh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/908,831

(22) Filed: May 27, 2005

(51) Int. Cl. H04N 7/00

(52) U.S. Cl. 386/95

(57) ABSTRACT

A method and system for decoding subpicture data. An exemplary method comprises (a) receiving a subpicture data stream; (b) pre-parsing the subpicture data stream to obtain address information containing the starting and ending address of each line of subpicture data, the subpicture data containing both top field pixel data and bottom field pixel data; (c) storing the address information in a display map table; (d) reading address information of a current entry in the display map table; (e) fetching corresponding subpicture data from the top field pixel data or the bottom field pixel data in accordance with the address information of the current entry in the display map table; (f) decoding the current subpicture data; and (g) reading address information of a next entry in the display map table before the current subpicture data is fully decoded.

### BACKGROUND

The invention relates to digital video processing, and more particularly, to a method and apparatus for utilizing a micro-processor created subpicture address table to fetch subsequent subpicture data before the previous subpicture data is fully decoded.

The decoded data on a DVD (which initials have been attributed to represent “digital versatile disc” and “digital video disc”) disc typically includes an audio stream, a main video image stream, and a sub-picture video image stream. The sub-picture typically overlays the main video image and may contain a variety of different types of information such as menus, sub-titles, and directives. The main video image and the sub-picture image are separately processed, then combined for simultaneous display on the screen.

DVD subpicture data is in a run-length bit format. Conventionally, there is no way to know whether the data been fetched is enough for one subpicture line unless the whole line of subpicture data is decoded. The subpicture data for DVD video is divided into a top field and a bottom field. When displaying subpicture data in interlaced mode, there should be no problem in fetching subpicture data. In interlaced mode, subpicture data is buffered in sequence from the same field, no matter if it is the top field or the bottom field. Then, the subpicture data for the next line is pre-fetched before the current line has finished decoding and been displayed.

However, under progressive scan mode, the subpicture data for the next line cannot be pre-fetched and buffered before the current line has been completely decoded because it is not possible to determine whether the next line will be in the same field (i.e. the top or bottom field) as the current line (usually, it will not be in the same field). If the subpicture data for the next line cannot be fetched before the next line should be displayed, decoding or display errors will occur.

### SUMMARY

Methods and apparatuses for pre-parsing subpicture data to more efficiently fetch and decode subpicture images are provided. An exemplary embodiment of a method of decoding subpicture data comprises (a) receiving a subpicture data stream; (b) pre-parsing the subpicture data stream to obtain address information containing the starting and ending address of each line of subpicture data, the subpicture data containing both top field pixel data and bottom field pixel data; (c) storing the address information in a display map table; (d) reading address information of a current entry in the display map table; (e) fetching corresponding subpicture data from the top field pixel data or the bottom field pixel data in accordance with the address information of the current entry in the display map table; (f) decoding the current subpicture data; and (g) reading address information of a next entry in the display map table before the current subpicture data is fully decoded.

An exemplary embodiment of a video processing circuit comprises a subpicture data stream source; a micro-processor for pre-parsing the subpicture data stream to obtain address information containing the starting and ending address of each line of subpicture data, the subpicture data containing both top field pixel data and bottom field pixel data; a memory buffer for storing the address information in a display map table; and a subpicture displaying device for reading address information of a current entry in the display map table, utilizing the address information of the current entry in the display map table to fetch corresponding subpicture data from the top field pixel data or the bottom field pixel data, decoding the current subpicture data, and reading address information of a next entry in the display map table before the current subpicture data is fully decoded.

An exemplary embodiment of a system for reproducing multimedia information comprises interface logic for receiving audio, video, and subpicture data streams; AV decoding circuitry for decoding the received audio and video data streams; and subpicture playback circuitry for decoding the received the subpicture data stream. The subpicture decoding circuitry comprises a micro-processor for pre-parsing the subpicture data stream to obtain address information containing the starting and ending address of each line of subpicture data, the subpicture data containing both top field pixel data and bottom field pixel data; a memory buffer for storing the address information in a display map table; and a subpicture displaying device for reading address information of a current entry in the display map table, utilizing the address information of the current entry in the display map table to fetch corresponding subpicture data from the top field pixel data or the bottom field pixel data, decoding the current subpicture data, and reading address information of a next entry in the display map table before the current subpicture data is fully decoded.

### BRIEF DESCRIPTION OF DRAWINGS

Fig. 1 is a block diagram of an exemplary embodiment multimedia reproducing system.

FIG. 2 is a functional block diagram of the subpicture playback device shown in FIG. 1.

FIG. 3 illustrates filling the display map table with the top field run-length data and the bottom field run-length data.

### DETAILED DESCRIPTION

In the example of DVD systems, a subpicture unit represents a subpicture image to be displayed on the screen, which comprises a subpicture unit header, pixel data, and a display command sequence table (DCSQT). The subpicture unit header provides information about the size of a subpicture unit and the start address of the DCSQT. The pixel data is further divided into two fields, a top field and a bottom field. The top and bottom field pixel data both contain a plurality of 2-bit values specifying how pixels of a subpicture image are to appear. For example, a pixel may be defined as a background pixel by “00”, as a pattern pixel by “01”, as the first emphasis pixel by “10”, and as the second emphasis pixel by “11”. Prior to storage or transmission, pixel data is generally compressed using a lossless compression algorithm such as the run-length encoding. The DCSQT provides timing and control information for a subpicture image, and contains a list of display control sequences each comprising a display control start time, the address of the next display control sequence, and a series of display control commands. The display control commands include timing, color, contrast, and other display characteristics; they operate to specify how each type of pixel of a subpicture image is to be displayed.

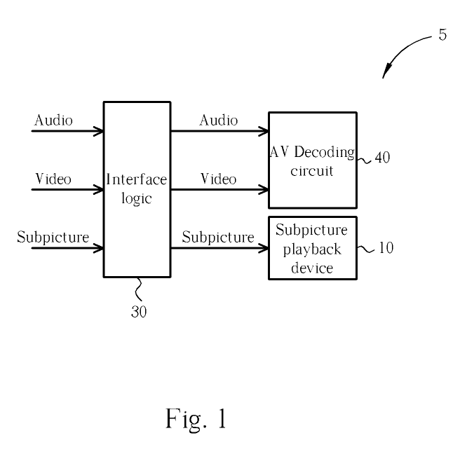

Please refer to FIG. 1. FIG. 1 is a block diagram of an exemplary embodiment multimedia reproducing system 5. The system 5 contains interface logic 30 for receiving audio, video, and subpicture streams. The audio and video streams are decoded by AV decoding circuitry 40, whereas the subpicture stream, comprising top field and bottom field run-length data, is decoded by a subpicture playback device 10.

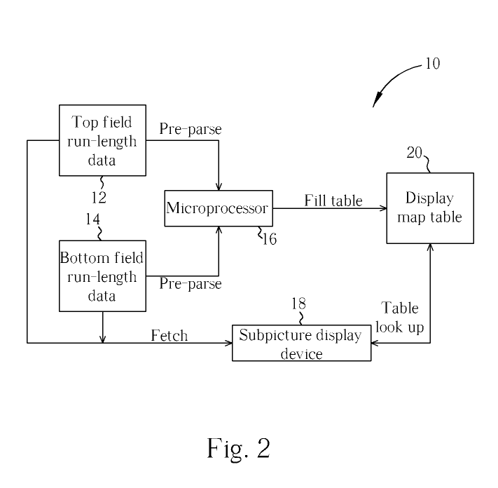

Please refer to FIG. 2. FIG. 2 is a functional block diagram of the subpicture playback device 10 shown in FIG. 1. The subpicture playback device 10 contains a microprocessor 16 for pre-parsing the top field run-length data 12 and the bottom field run-length data 14 received in the subpicture data stream. The microprocessor 16 pre-parses the top field run-length data 12 and the bottom field run-length data 14 in order to record the starting address and the ending address of each line of stored subpicture data. When pre-parsing the run-length data, the microprocessor 16 decodes SubPicture Display Control SeQuence (SPDCSQ) command data contained in the subpicture data.

The microprocessor 16 then stores the pre-parsed line information into a display map table 20. The subpicture playback device 10 also contains a subpicture display device 18 used to display subpicture data. The subpicture display device 18 accesses the display map table 20 to determine the address information for subpicture lines to be displayed, and then fetches the corresponding subpicture data from the specified address. That is, the display map table 20 provides the subpicture display device 18 with the address in either the top field run-length data 12 or the bottom field run-length data 14 from which the subpicture display device 18 should fetch data. After fetching the subpicture data, the subpicture display device 18 then decodes the data. At this point, the decoded subpicture data can be displayed in a variety of ways known to those skilled in the art.

The exemplary embodiment is unique in that after the subpicture display device 18 fetches one line of subpicture data from either the top field run-length data 12 or the bottom field run-length data 14, the subpicture display device 18 can immediately access the display map table 20 to look up the address of the next line of subpicture data. That is, the subpicture display device 18 can read the address information of the next line of subpicture data before the previous line of subpicture data is fully decoded. When displaying subpicture data in progressive scan mode, successive picture data will be fetched from the top field pixel data and the bottom field pixel data in an alternating manner if no vertical scaling operations are performed.

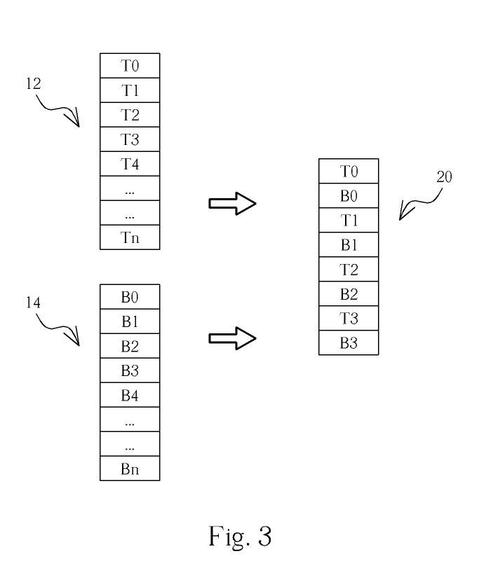

Please refer to FIG. 3. FIG. 3 illustrates filling the display map table 20 on the basis of the top field run-length data 12 and the bottom field run-length data 14. The display map table 20 can be implemented as a memory buffer, and preferably is a first-in first-out (FIFO) memory buffer. The memory buffer can be SRAM, DRAM, or any other suitable memory type. As an example, the display map table 20 shown in FIG. 3 can hold eight lines of subpicture data at a time. Of course, the size of the memory buffer can be adjusted to any size needed to be able to display subpicture data properly. Ultimately, the subpicture playback device 10 has the advantage in that only a small memory buffer is needed for storing the display map table 20.

The subpicture playback device 10 also has the advantage of being able to perform vertical scaling as the display map table 20 is being filled. For example, if the vertical size of the subpicture data is to be scaled up, the microprocessor 16 can add an extra copy of the address data of various subpicture lines to the display map table 20 so that the vertical dimension is increased. On the contrary, if the vertical size of the subpicture data is to be scaled up, the microprocessor 16 can skip adding the address data of various subpicture lines to the display map table 20 in order to decrease the vertical dimension.

The subpicture playback device 10 can be used for playing DVD subpicture data or for displaying subpicture data of any digital video format. The subpicture playback device 10 makes use of a small memory buffer for storing the display map table 20, and the display map table 20 allows the subpicture playback device 10 to efficiently fetch subpicture data from the top field run-length data 12 and the bottom field run-length data 14 to prevent errors in subpicture playback.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of decoding subpicture data, the method comprising steps:
(a) receiving a subpicture data stream;
(b) pre-parsing the subpicture data stream to obtain address information containing the starting and ending address of each line of subpicture data, the subpicture data containing both top field pixel data and bottom field pixel data;
(c) storing the address information in a display map table;
(d) reading address information of a current entry in the display map table;
(e) fetching corresponding subpicture data from the top field pixel data or the bottom field pixel data in accordance with the address information of the current entry in the display map table;
(f) decoding the current subpicture data; and
(g) reading address information of a next entry in the display map table before the current subpicture data is fully decoded.

2. The method of claim 1 further comprising the step of repeating steps (e) to (g) for fetching and decoding subsequent subpicture data.

3. The method of claim 1, wherein pre-parsing the subpicture data stream to obtain address information comprises decoding SubPicture Display Control SeQuence (SPDCSQ) command data contained in the subpicture data.

4. The method of claim 1, wherein the display map table is stored in a memory buffer.

5. The method of claim 1, wherein the subpicture data stream is a DVD subpicture data stream.

6. A video processing circuit, comprising:
a subpicture data stream source;
a micro-processor for pre-parsing the subpicture data stream to obtain address information containing the starting and ending address of each line of subpicture data, the subpicture data containing both top field pixel data and bottom field pixel data;
a memory buffer for storing the address information in a display map table; and
a subpicture displaying device for reading address information of a current entry in the display map table, utilizing the address information of the current entry in the display map table to fetch corresponding subpicture data from the top field pixel data or the bottom field pixel data, decoding the current subpicture data, and reading address information of a next entry in the display map table before the current subpicture data is fully decoded.

7. The video processing circuit of claim 6, wherein the micro-processor decodes SubPicture Display Control SeQuence (SPDCSQ) command data contained in the subpicture data to obtain the address information.

8. The video processing circuit of claim 6, wherein the subpicture data stream is a DVD subpicture data stream.

9. A system for reproducing multimedia information, comprising:
interface logic for receiving audio, video, and subpicture data streams;
AV decoding circuitry for decoding the received audio and video data streams; and
subpicture playback circuitry for decoding the received the subpicture data stream, the subpicture decoding circuitry comprising:
a micro-processor for pre-parsing the subpicture data stream to obtain address information containing the starting and ending address of each line of subpicture data, the subpicture data containing both top field pixel data and bottom field pixel data;
a memory buffer for storing the address information in a display map table; and
a subpicture displaying device for reading address information of a current entry in the display map table, utilizing the address information of the current entry in the display map table to fetch corresponding subpicture data from the top field pixel data or the bottom field pixel data, decoding the current subpicture data, and reading address information of a next entry in the display map table before the current subpicture data is fully decoded.

10. The system of claim 9, wherein the micro-processor decodes SubPicture Display Control SeQuence (SPDCSQ) command data contained in the subpicture data to obtain the address information.

11. The system of claim 9, wherein the subpicture data stream is a DVD subpicture data stream.
